(19) United States
(12) Patent Application Publication
(10) Pub. No.: US 2025/0127290 A1
(43) Pub. Date: Apr. 24, 2025

(54) RECEPTACLE DEVICE FOR A HOLDING DEVICE FOR A TOOL AND RECEPTACLE DEVICE WITH SUPPORTING DEVICE WITH SUPPORTING PART

(71) Applicant: MARTOR KG, Solingen (DE)

(72) Inventors: Martin ROHRBACH, Göggingen (DE); Kerry HENN, Solingen (DE)

(21) Appl. No.: 18/919,881

(22) Filed: Oct. 18, 2024

(30) Foreign Application Priority Data
Oct. 23, 2023 (DE) 10 2023 129 092.4

(51) Int. Cl. A45F 5/00; A45F 5/02

(52) U.S. Cl. CPC A45F 5/1575; A45F 5/02

(57) ABSTRACT

A fastening device for fastening a portable receiving device for a tool to a piece of clothing or a piece of furniture, wherein the receiving device is provided with a receiving space for receiving the tool and with a first retaining device for mounting the receiving device on the fastening device. A second retaining device is assigned to the fastening device and interacts with the first retaining device of the fastening device. The fastening device includes a first contact surface and a second contact surface, which face one another, wherein a bar-like carrying piece can be releasably positioned between the first contact surface and the second contact surface.

The invention first relates to a fastening device for a receiving device for a tool. A fastening device of this kind is known from public prior use. The fastening device comprises e.g. first retaining means, which are assigned to the receiving device, and second retaining means, which are assigned to the fastening device and interact with the first retaining means.

The first retaining means and second retaining means are part of a retaining device for connecting the receiving device to the fastening device.

The fastening device is provided to mount the receiving device on and fasten it to a piece of clothing, e.g. a belt.

The problem addressed by the invention was to provide a fastening device for a receiving device which is improved in terms of its fastening flexibility.

The problem was solved by a fastening device having the features of claim 1.

The fastening device is provided for mounting a portable receiving device for a tool on and fastening it to a carrying device. This carrying device is e.g. a piece of clothing, such as a belt, or wall of a piece of furniture or a property. The receiving device is provided with a receiving space for receiving the tool and with a retaining device for mounting the receiving device on the fastening device. Second retaining means are assigned to the fastening device and interact with first retaining means of the receiving device. The fastening device comprises a first contact surface and a second contact surface, which face one another, wherein a bar-like rigid or flexible carrying part can be releasably positioned between the first contact surface and the second contact surface.

Using the fastening device according to the invention, it is possible, in a simple manner, to fasten the receiving device to a piece of clothing, in particular a belt, or to a piece of furniture or a wall. The tool can then be kept within easy reach in the receiving device and is always ready to use and is safely mounted in the receiving device such that the user or a third party cannot injure themselves on the tool.

The first contact surface is e.g. assigned to the receiving device or to a base part, which is connected to the second retaining means. If the first contact surface is formed by a surface of the receiving device, a separate part is not necessarily required to form the first contact surface. If a separate part is provided to form the first contact surface, this can be equipped with further features of the receiving device.

The second contact surface is e.g. assigned to a closure part, which forms a joint together with the base part or the receiving device. In this case, the second contact surface is assigned to a separate part, which is movably connected to the base part or the receiving device by means of a joint, e.g. a hinged joint. A free end region of the closure part can be spread apart by the first contact surface in this way, in order to position a carrying part between the first contact surface and the second contact surface.

Alternatively, the first contact surface and the second contact surface are e.g. assigned to a fastening part, which is connected to the second retaining means. The first contact surface and the second contact surface are formed on one part in this case. This part e.g. also comprises the second retaining means for connecting the fastening device to the retaining device.

The fastening part is e.g. U-shaped and comprises a first leg, to which the first contact surface is assigned, and a second leg, to which the second contact surface is assigned.

The first leg and the second leg of the U-shaped fastening part are e.g. interconnected by means of a resilient region. To arrange the carrying part between the legs, a free end region of the second leg can be spread apart relative to the first leg while deforming the resilient region. The second leg can be provided with resilient preloading. This can prevent the fastening device and thus the receiving device from moving relative to the carrying part and being released from the carrying part.

According to an alternative configuration, a bar of the U-shaped fastening part connecting the first leg and the second leg is e.g. opposite an opening, which can be shut by means of a shutting part. The shutting part is e.g. fastened to one leg by a hinge or a film hinge and can be locked to the other leg. The shutting part can then be released for fastening to the carrying part and, once the carrying part has been arranged between the contact surfaces, can be locked again. In this case, the fastening part and therefore the receiving device cannot be released from the carrying part in a locked position of the shutting part.

According to a second aspect, the invention also comprises a fastening device comprising a carrying device having a carrying part. The carrying part is e.g. formed by a piece of clothing, such as a belt, a carrying element as part of a piece of furniture or a wall, or a carrying adapter, which can be fastened to a wall of a piece of furniture or a property. It is then possible to fasten the fastening device of the receiving device to different carrying parts.

If the receiving device is to be carried by the user, the fastening device can e.g. be fastened to a belt or another piece of clothing. If the receiving device is to be e.g. retained on a machine or a wall of the user's work area, a carrying part configured as a carrying adapter can be fastened to the machine or the wall. The fastening device can be readily mounted on the carrying adapter. The fastening can be performed by way of screwing, riveting, etc., by adhesion or using wires, cable ties, etc.

The carrying part e.g. comprises at least one fastening region to which it can be fastened. The fastening region e.g. comprises means for fastening, such as at least one drilled hole, at least one eye-like or tab-like fastening means, adhesive surfaces, etc.

For example, the fastening region is formed in a fastening plane and a mounting region is substantially formed in a mounting plane, which is at a distance from the fastening plane. Owing to the distance between the mounting plane and the fastening plane, it is possible, in a simple manner, to guide the shutting part or the second leg through between the fastening wall and the mounting region such that the first contact surface is in contact with a front side of the mounting region and the second contact surface is in contact with a rear side of the mounting region.

The carrying part is e.g. configured as a planar plate or a plastics part, the longitudinal extension and width extension of which is large in comparison with the thickness.

The tool is e.g. configured as a cutter or comprises a cutter.

Exemplary embodiments of the invention are described by way of example in the following description of the figures, also with reference to the drawings. Here, for the sake of clarity, even if different exemplary embodiments are involved, identical or comparable parts or elements or regions have been denoted by identical reference signs, sometimes with the addition of lower case letters.

Features that are only described in relation to one exemplary embodiment can also be provided in any other exemplary embodiment of the invention within the scope of the invention. Even if they are not shown in the drawings, such amended exemplary embodiments are covered by the invention.

All the features disclosed are essential to the invention per se. The content of the disclosure of the associated priority documents (copy of the previous application) and the cited documents and the prior art devices described as well as the patent applications having the file references DE 10 2023 129 074.6 and DE 10 2023 129 075.4, which were filed on the same date, are hereby incorporated into the disclosure of the application in their entirety, also for the purpose of incorporating individual features or a plurality of features of these documents into one or more claims of the present application.

In the drawings:

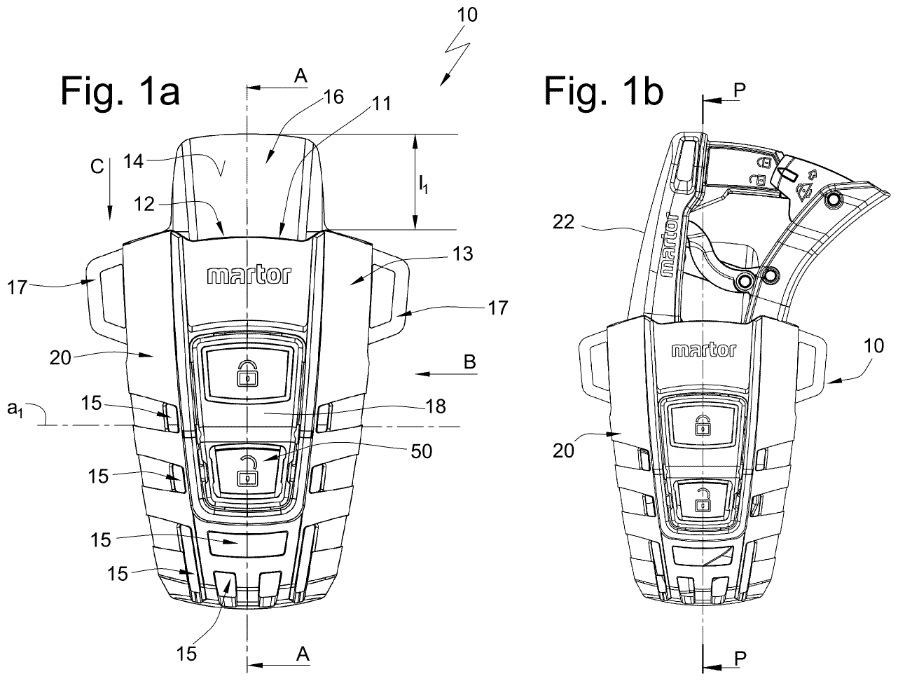

FIG. 1a is a front view of the carrying device,

FIG. 1b is a front view according to FIG. 1a, wherein a cutter is retained in the carrying device,

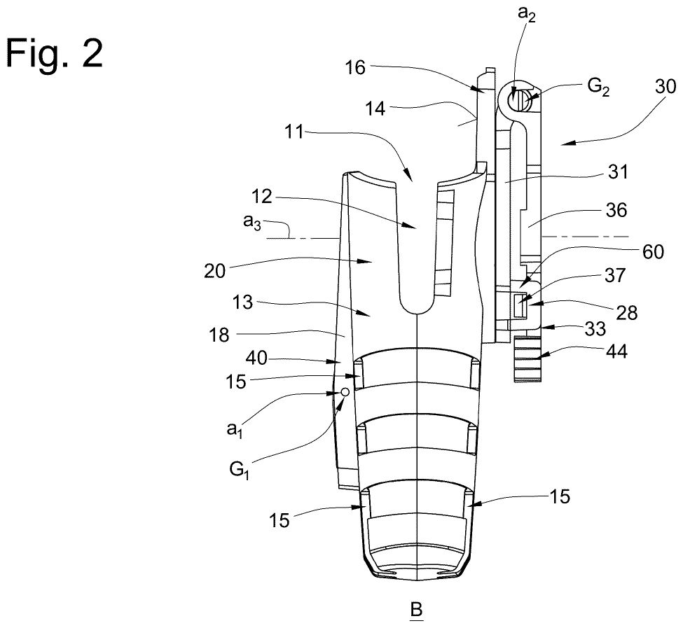

FIG. 2 is a view from the direction of the arrow B in FIG. 1a,

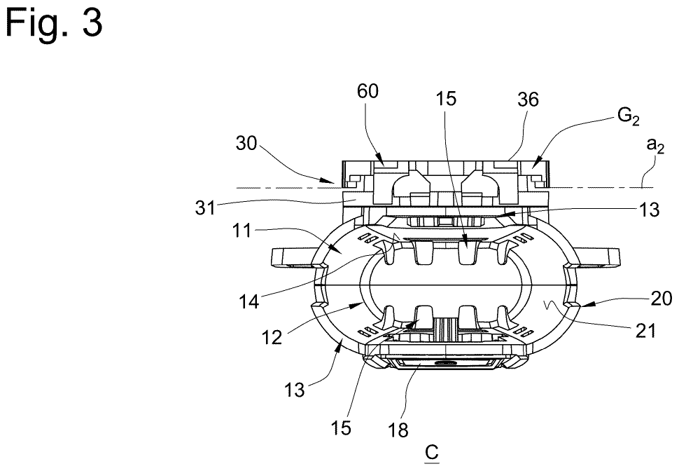

FIG. 3 is a view from the direction of the arrow C in FIG. 1a,

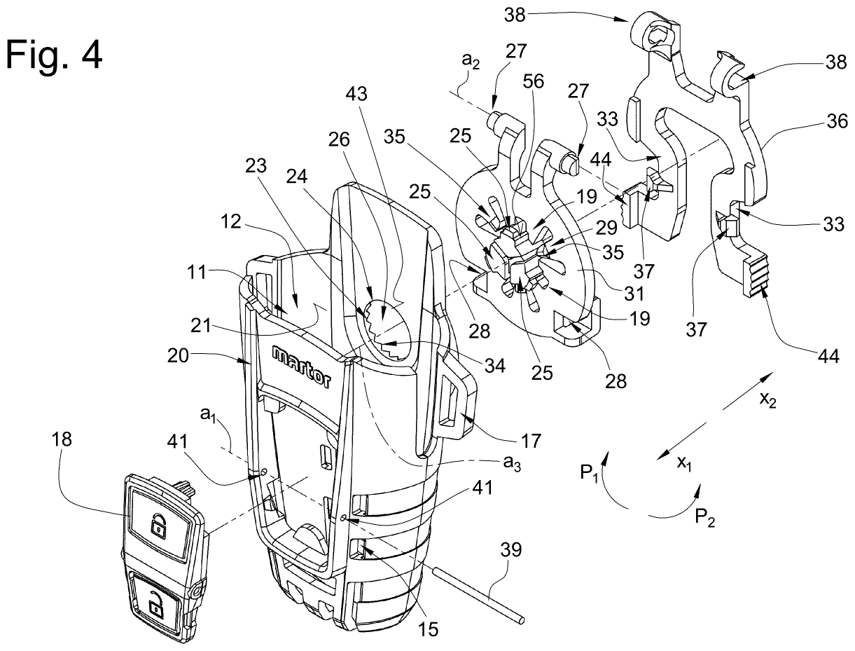

FIG. 4 is an exploded view of the carrying device,

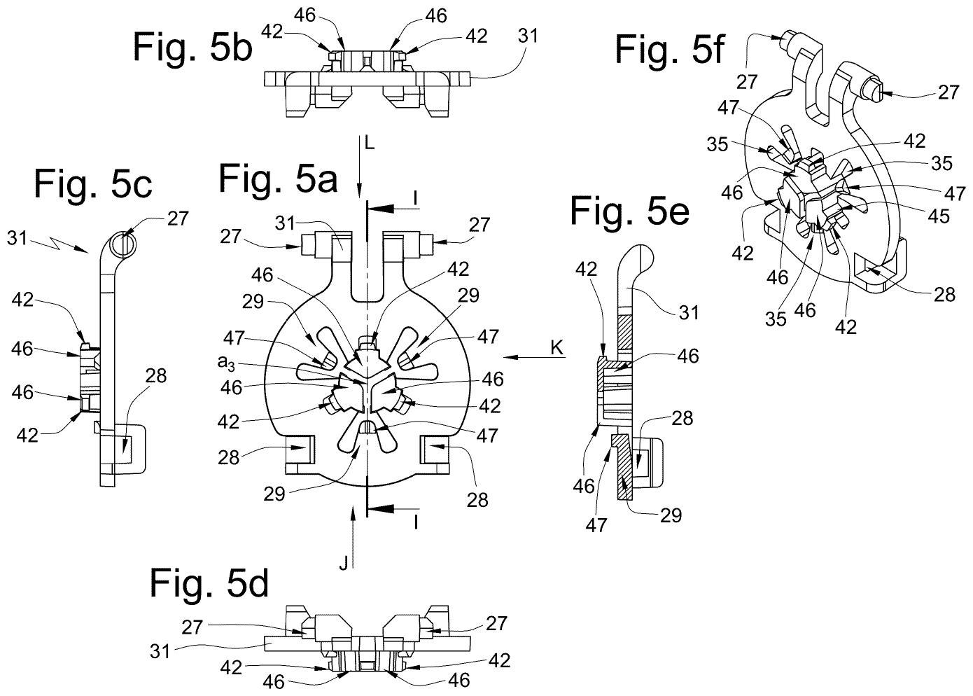

FIG. 5a is a front view of a base part of the retaining device shown as an individual part,

FIG. 5b is a view from the direction of the arrow J in FIG. 5a,

FIG. 5c is a view from the direction of the arrow K in FIG. 5a,

FIG. 5d is a view from the direction of the arrow L in FIG. 5a,

FIG. 5e is a sectional view along sectional line I-I in FIG. 5a,

FIG. 5f is a perspective view of the base part,

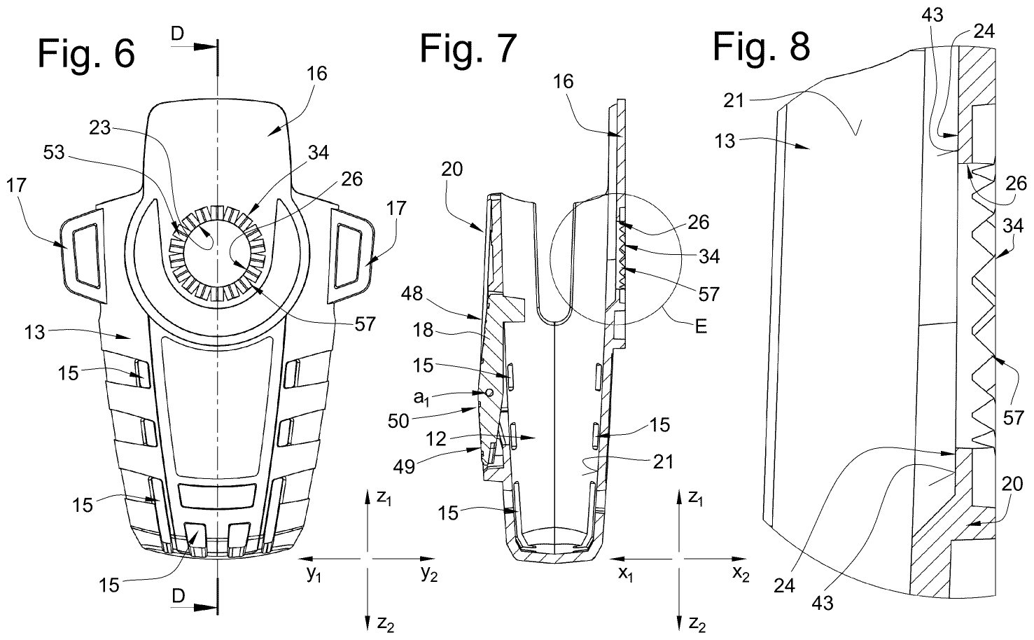

FIG. 6 is a rear view of the receiving device of the carrying device without the retaining device,

FIG. 7 is a sectional view along sectional line D-D in FIG. 6,

FIG. 8 is an enlarged view of the detail E in FIG. 7,

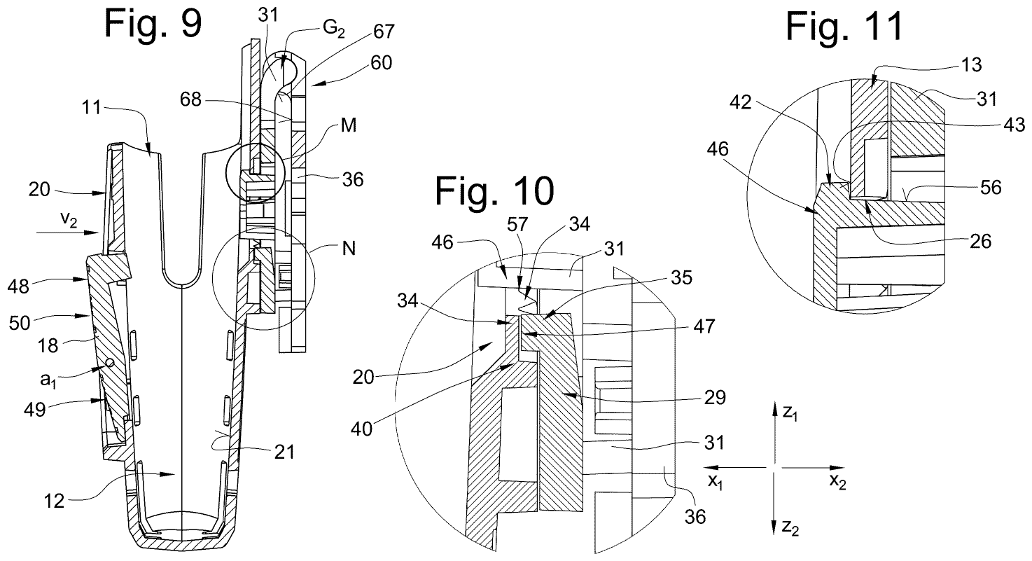

FIG. 9 is a sectional view along sectional line A-A in FIG. 1,

FIG. 10 is an enlarged view of the detail M in FIG. 9,

FIG. 11 is an enlarged view of the detail N in FIG. 9,

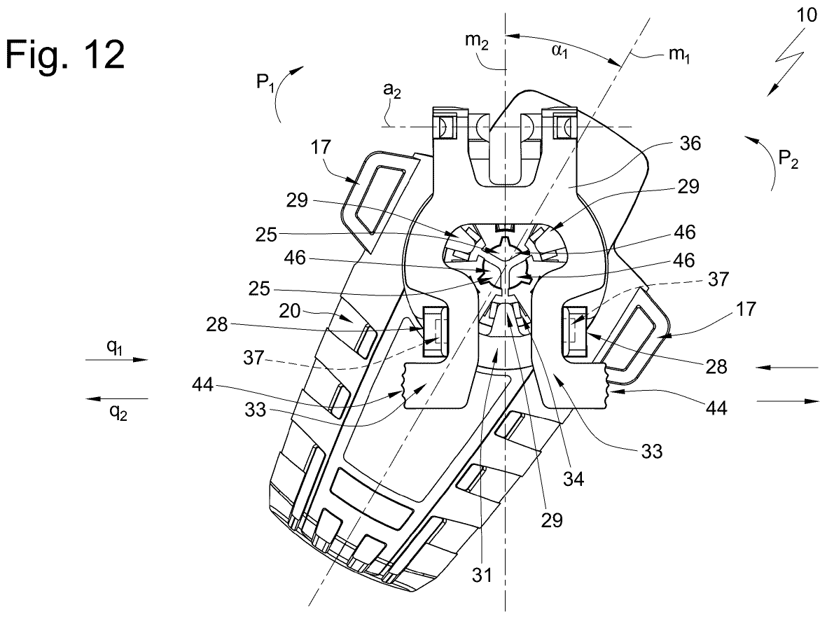

FIG. 12 is a rear view of the carrying device, wherein the receiving device is in a first angular position relative to the retaining device,

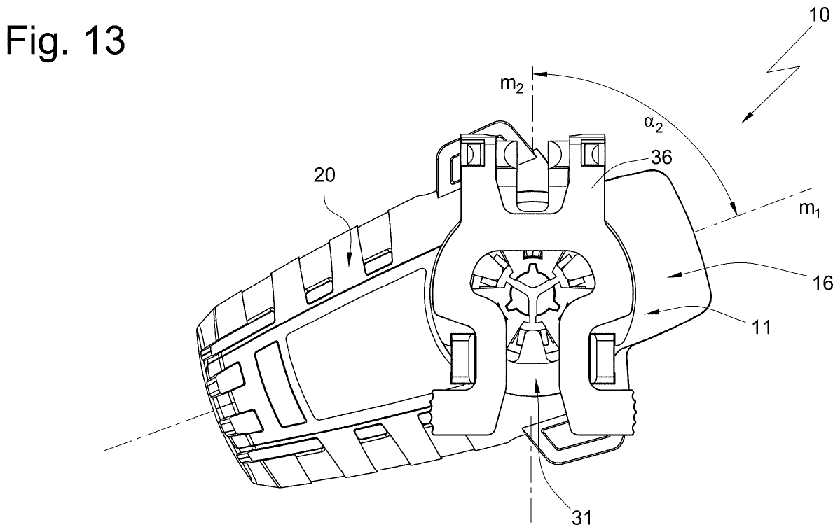

FIG. 13 is a rear view of the carrying device, wherein the receiving device is in a second angular position relative to the retaining device,

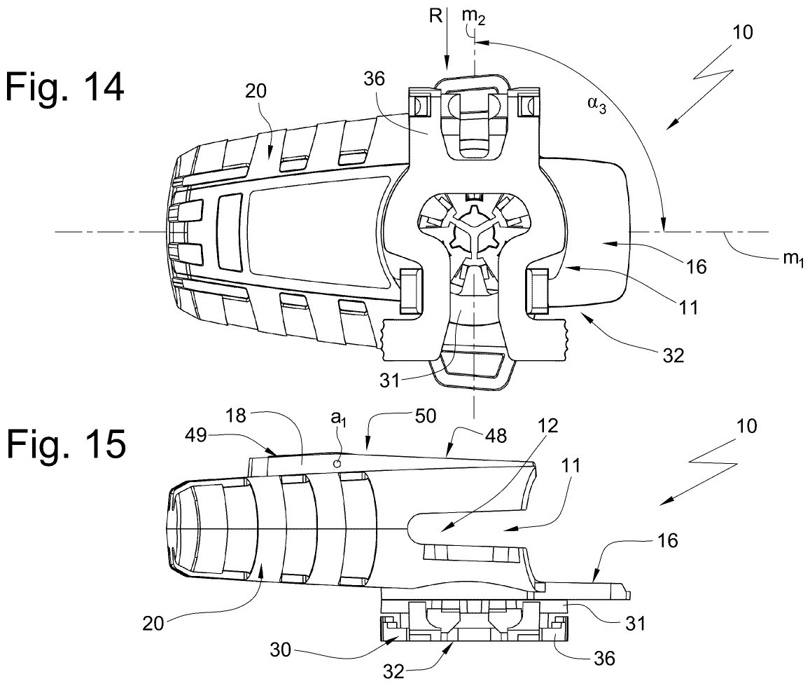

FIG. 14 is a rear view of the carrying device, wherein the receiving device is in a third angular position relative to the retaining device,

FIG. 15 is a view from the direction of the arrow R in FIG. 14,

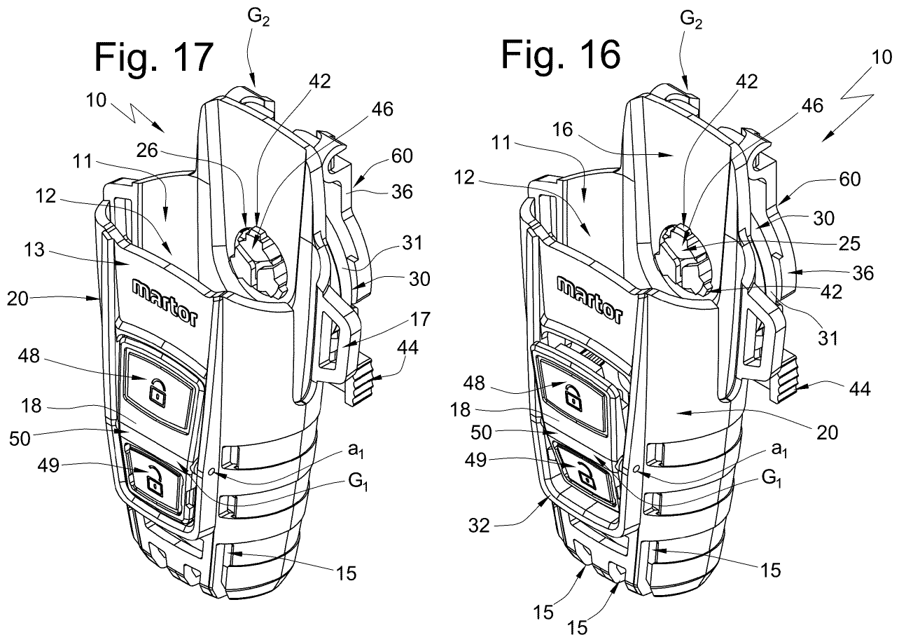

FIG. 16 is a perspective view of the carrying device, wherein a button of a locking device is arranged in a locking position,

FIG. 17 is a perspective view of the carrying device based on FIG. 16, wherein the button is arranged in a released position,

FIG. 18 is a front view of the carrying device in the locking position,

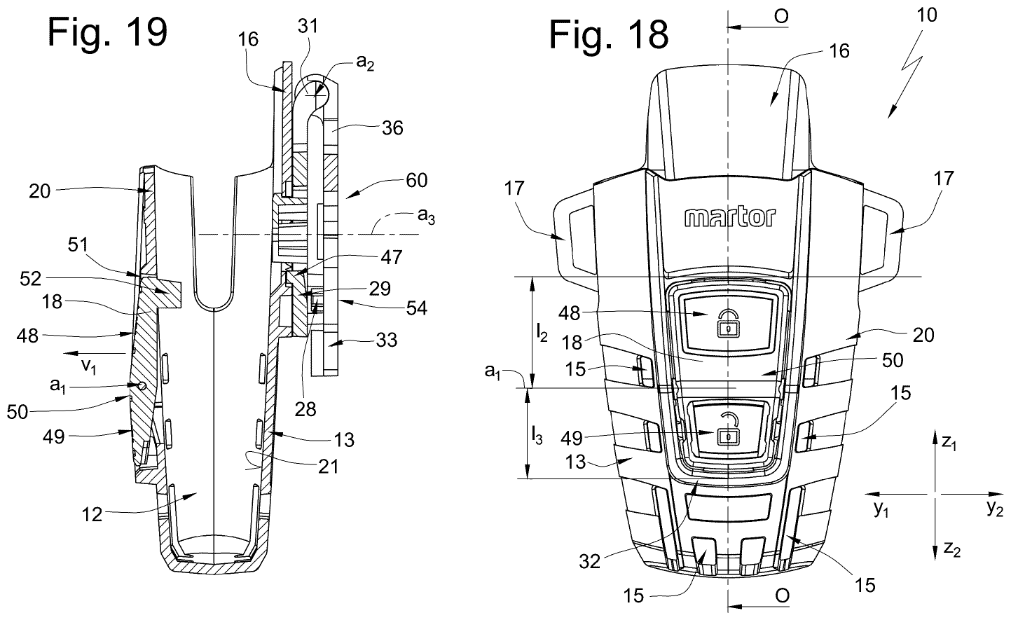

FIG. 19 is a sectional view along sectional line O-O in FIG. 18,

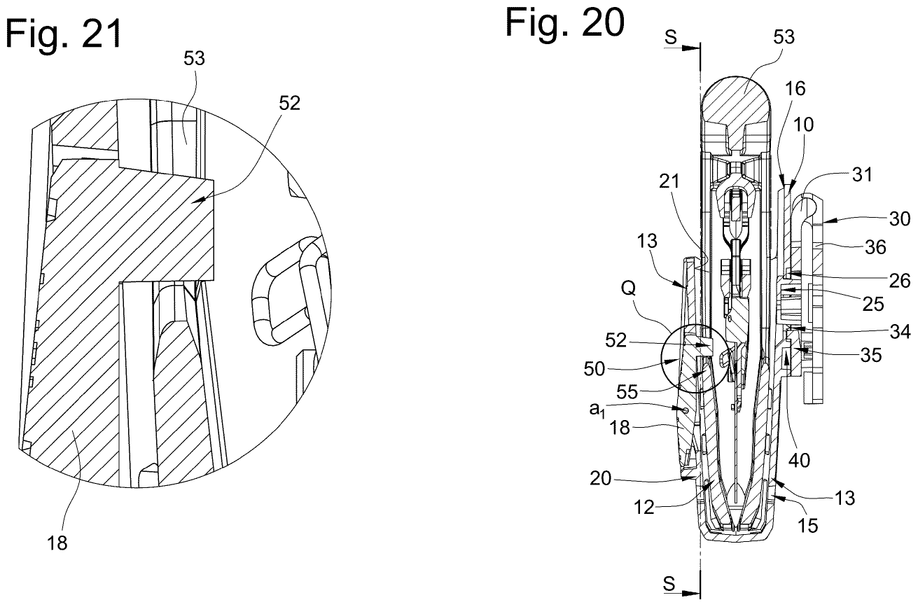

FIG. 20 is a sectional view along sectional line P-P in FIG. 1b,

FIG. 21 is an enlarged view of the detail Q in FIG. 20,

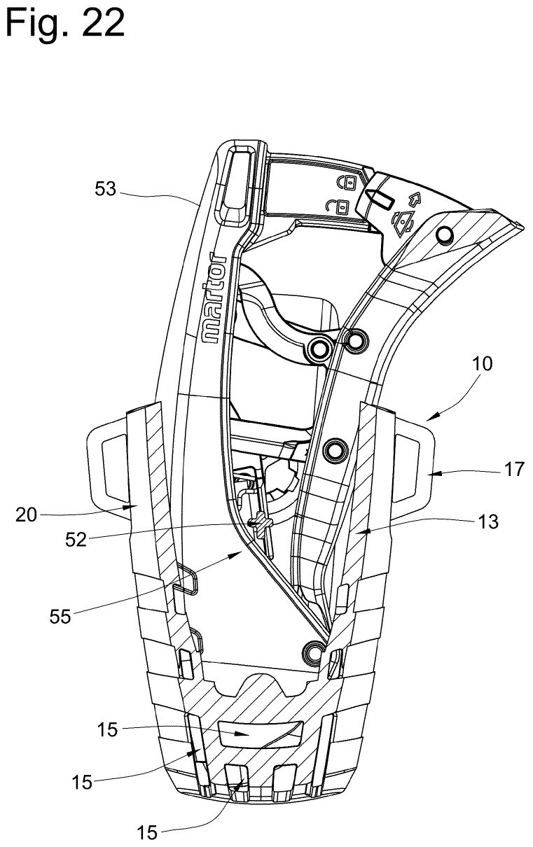

FIG. 22 is a sectional view along sectional line S-S in FIG. 20,

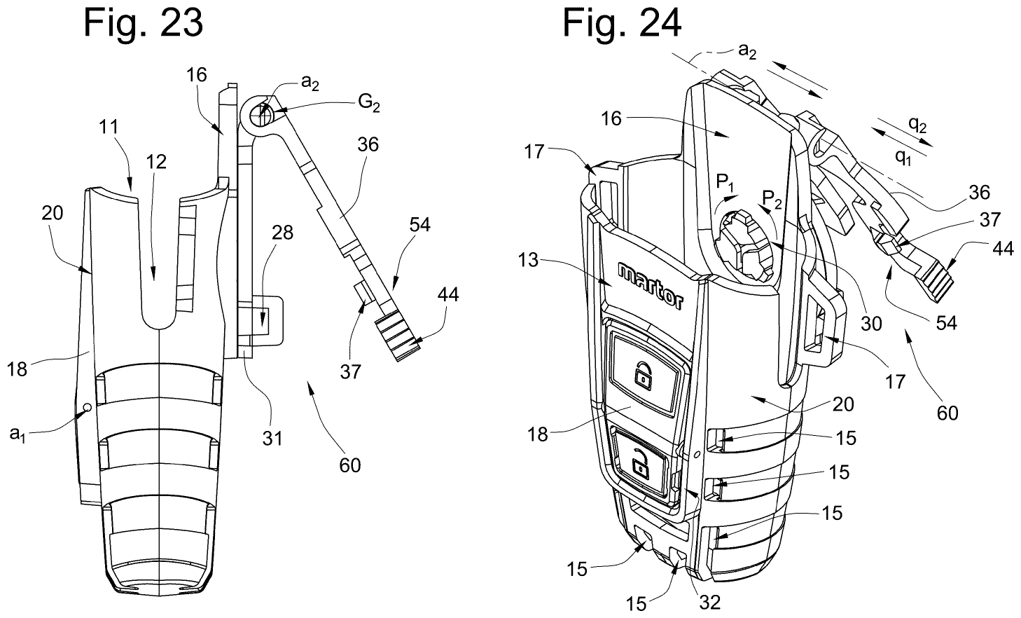

FIG. 23 is a side view based on FIG. 2, wherein a hinge part of the closure device is arranged in an open position,

FIG. 24 is a perspective view of the carrying device according to FIG. 23,

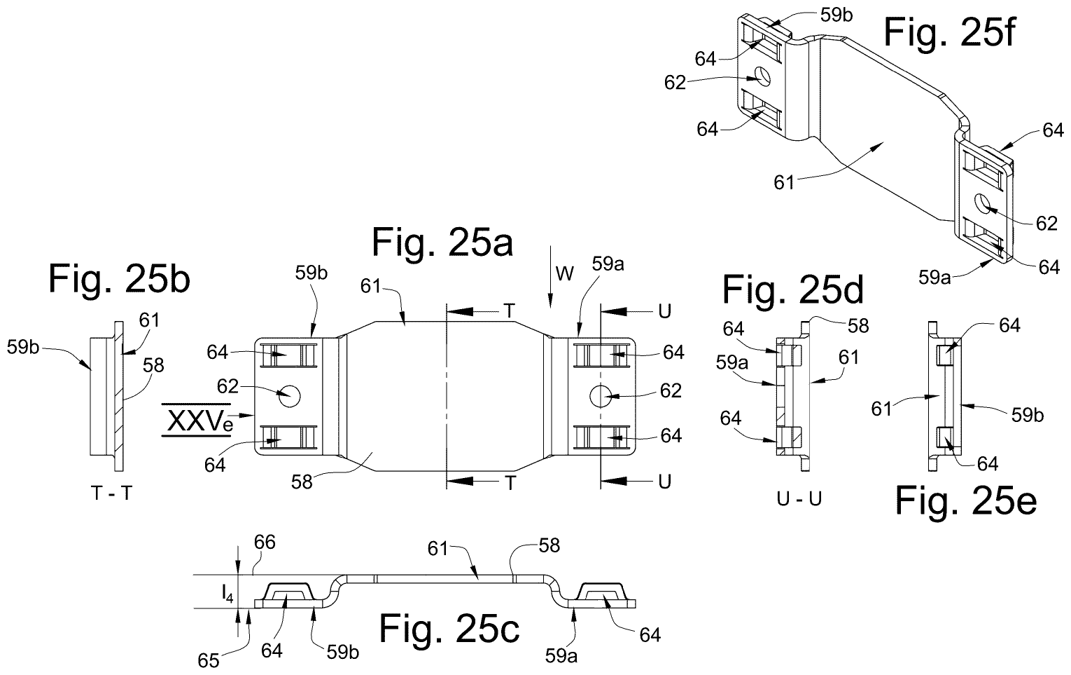

FIGS. 25a to 25f show a carrying part e.g. for fastening the carrying device to a wall of a piece of furniture or a building, shown as an individual part,

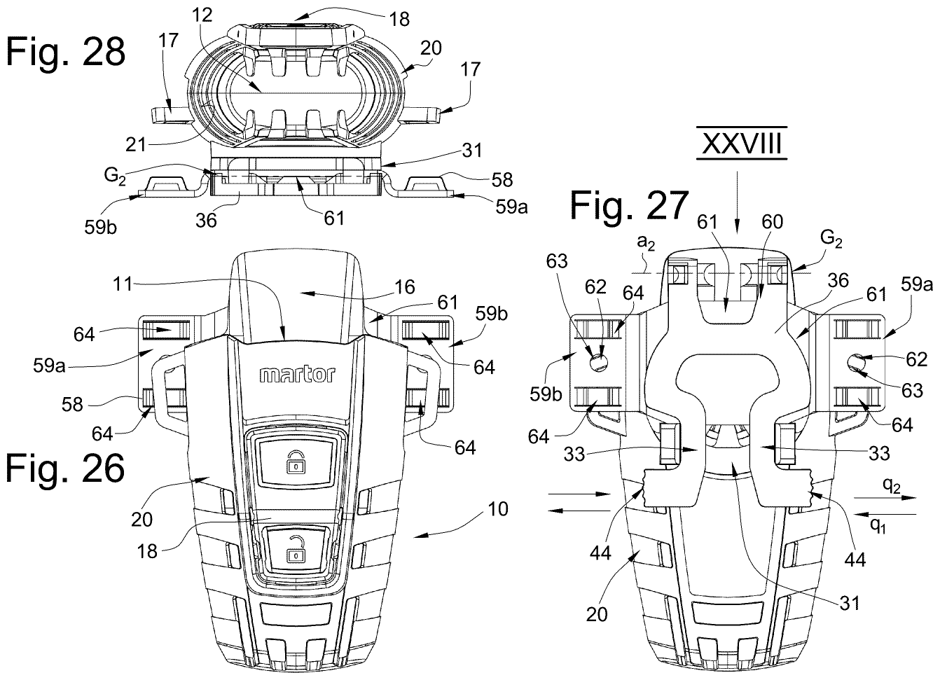

FIG. 26 is a front view of the receiving device, which is fastened to a carrying part according to FIGS. 25a to 25f,

FIG. 27 and FIG. 28 are a rear view and a plan view, respectively, of the device according to FIG. 26,

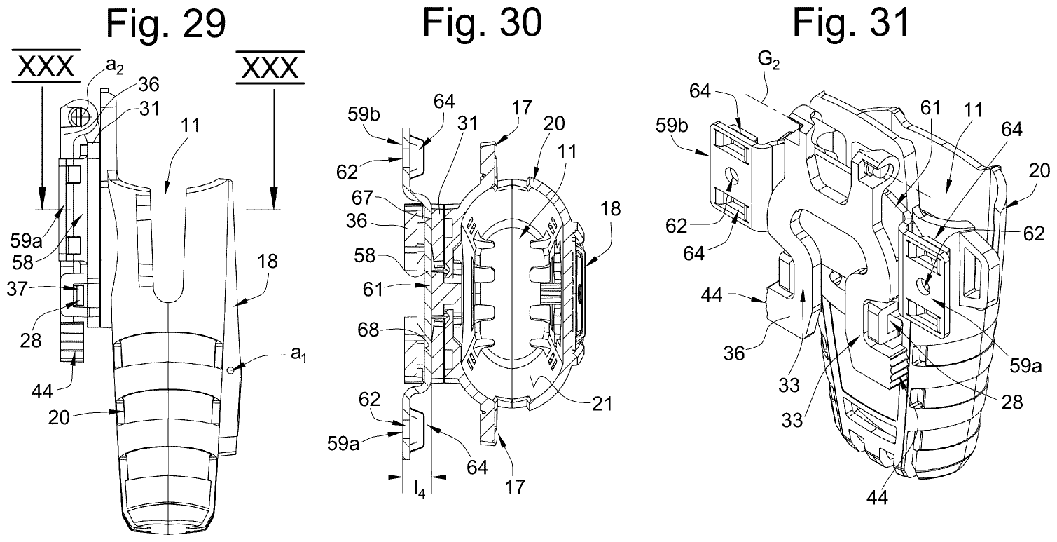

FIG. 29 is a side view of the device according to FIG. 26,

FIG. 30 is a sectional view along sectional line XXX-XXX in FIG. 29,

FIG. 31 is a perspective view of the device according to FIG. 26,

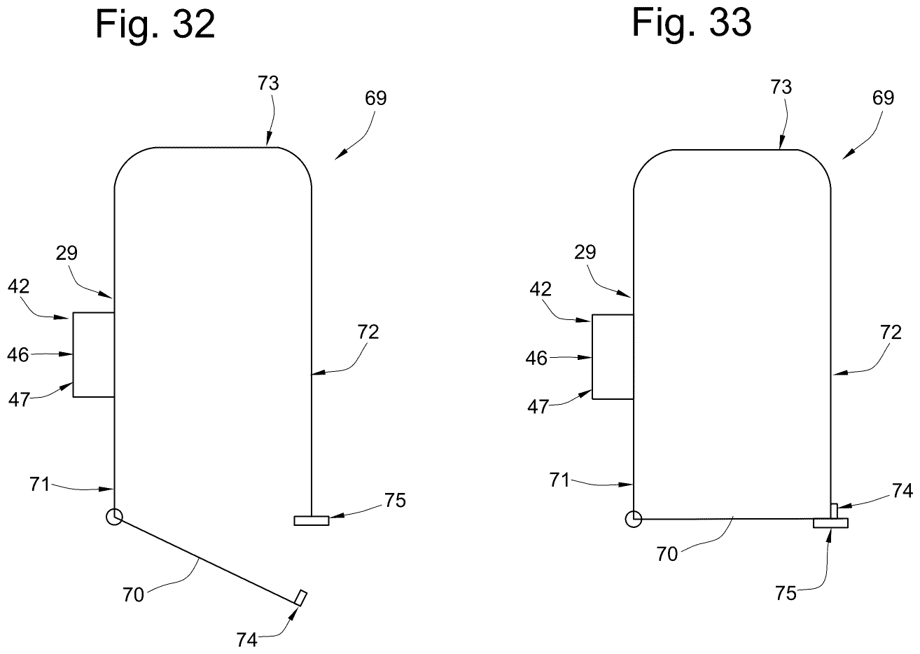

FIG. 32 shows a modified embodiment of a U-shaped fastening part, wherein a shutting part is in an open position, and

FIG. 33 shows a modified embodiment of a U-shaped fastening part, wherein a shutting part is in a closed position.

A carrying device as a whole is denoted by reference sign 10 in the drawings. FIG. 1a is a front view of the carrying device 10. The carrying device 10 is used to receive a tool, in the form of a cutter 22 here, as shown in FIG. 1b. The carrying device 10 comprises a receiving device 20, a retaining device 30 and a locking device 40.

The receiving device 20 is configured in the manner of a housing and comprises a receiving space 12, which is delimited by a wall 13. The cutter can be inserted into and removed from the receiving space 12 via an upper opening 11. A wall region 16 forms a guide surface 14, which guides the cutter 22 into the receiving space. An upper end of the wall 16 projects beyond an upper edge of the opening 11 by a length I.

Openings 15 in the wall 13 give the carrying device 10 a visually appealing appearance and allow particles of dirt that have got into the receiving space 12 to escape. Fastening means in the form of eyes 17 allow a cable or strap (not shown), which is connected to the cutter 22 at the other end, or other objects to be fastened to the carrying device 10. The wall 13 is configured such that it is not possible for anyone to touch a cutting edge of the cutter 22 and injure themselves when the cutter 22 is in the receiving space 12. The receiving device 20 is e.g. substantially made of plastics material. For example, metal and composite plastics materials can also be used for the receiving device 20.

To secure the cutter 22 in the receiving space 12 against unintentionally falling out, the carrying device 10 comprises a locking device 50 in the present exemplary embodiment. Said device comprises a button 18, by means of which the locking device 50 can be switched between a locking position and a released position. The cutter 22 is secured in the receiving space 12 in the locking position and the cutter 22 can be removed from the receiving space 12 in the released position. In the present exemplary embodiment, the button 18 is configured as a rocker button which is adjustable between the locking position and the released position. Alternatively, however, other types of actuation are also taken into consideration. The locking device 50 is explained in greater detail below.

FIG. 2 is a side view of the carrying device 10. It shows a base part 31, which is part of a retaining device 30 and part of a fastening device 60, e.g. to fasten the receiving device 20 to the user's clothing or to a piece of furniture. The receiving device 20 is releasably fastened to the base part 31 and is pivotally mounted on the base part 31 about a pivot axis a3 by means of the retaining device 30, which is not shown in full in FIG. 2. This mounting is configured as a sliding bearing in this example. Alternatively, other bearings could be used. However, in this case, a sliding bearing provides the option of easily releasing the receiving device 20 from the base part 31 and only incurs low costs.

In this exemplary embodiment, the receiving device 30 is pivotable by 360° relative to the base part 31. Alternatively, however, the pivot radius could be limited.

FIG. 3 is a plan view of the carrying device in which the receiving space 12 can be seen through the opening 11. Openings 15 can be seen on the base of the receiving device 20, through which particles of dirt can escape from the receiving space 12.

FIG. 4 is an exploded view of the carrying device 10. FIG. 4 shows the button 18, the receiving device 20, the base part 31 and a closure part 36. The base part 31 comprises second retaining means 25, which interact with first retaining means 24 of the receiving device in order to ensure releasable fastening and rotatable mounting. The first retaining means 24 are formed by an edge surface 43 of a cut-out 26 in the wall 13 of the receiving device 20. The edge surface 43 is part of an inner surface 21 of the receiving device 20. In other words, the edge surface 43 surrounds the cut-out 26 and, together with hook projections 42 of the base part 31, prevents the base part 31 from being released from the receiving device 20.

In this exemplary embodiment, the second retaining means 25 are in the form of three separate blocks 46, which project from the planar base part 31 in the direction x1 towards the receiving device 20, wherein each block 46 is mounted on an end region of at least one spring bar 19, which is elastically deformable. In this way, each block 46 can be moved radially inwards counter to the resilient spring force of the spring bar 19. Gaps between the blocks 46 allow for the radially inward movement. A bearing surface 56 of all three blocks 46 together results in the shape of a circular cylinder, which is intended to penetrate the cut-out 26 and form a joint bearing surface for the rotatable mounting. The number of blocks has been selected here by way of example. Alternatively, two or four blocks 46 could e.g. also be provided, the bearing surfaces 56 of which form a joint bearing surface for the rotatable mounting of the receiving device 20.

Each block 46 is provided with a hook projection 42 (see FIG. 5a), which projects radially outwards from a free end region of each block 46. When each block 46 moves resiliently inwards, the blocks 46 can be guided through the cut-out 26 in the direction x1 when mounting the receiving device 20 on the base part 31. When the load is removed, the blocks move radially outwards, wherein each hook projection 42 engages over the edge surface 43 of the cut-out 26 on a side of the wall 13 opposite the base part 31. If that is the case, the base part 31 cannot be moved in the direction x2 and released from the receiving device 20. The rotatability of the receiving device 20 relative to the base part 31 in the directions p1 and p2 is ensured owing to the interaction of the bearing surface 56 with the recess 23.

While mounting the base part 31 in the direction x1 relative to the receiving device 20, oblique surfaces on the hook projections 42 assist the radial movement inwards when they come into contact with the recess 23 of the cut-out 26. To dismount the base part 31, the blocks 46 can be moved radially inwards by applying pressure to their joint centre (pivot axis a3), and the retaining means 25 can then be released from the receiving device 20 in the direction x2. This ability to release the receiving device 20 from the base part 31 facilitates and simplifies cleaning of the carrying device 10.

Each of the three blocks 46 comprises bar projections 45 extending in the direction in parallel with the pivot axis a3 on the bearing surface 56. When the first retaining means 24 are in engagement with the second retaining means 25, said projections are in contact with the recess 23 of the cut-out 26 and, together with said cut-out, form a sliding bearing for rotatably mounting the receiving device 20 relative to the base part 31 in the directions p1 and p2 about the pivot axis a3.

The locking device 40 of the carrying device 10 is configured to secure the set rotational position of the receiving device 20 relative to the base part 31. The locking device 40 comprises first latching means 34 (see FIG. 6 to 11), which are assigned to the receiving device 20, and second latching means 35, which are assigned to the base part 31. In this exemplary embodiment, the second latching means 35 (see also FIG. 5a to 5f) comprise a toothed projection 47, which extends in the direction x1 and is directed towards the first latching means 34.

The toothed projection 47 is formed on a free end region of a spring bar 29, which is free in the plane of the planar base part 31. In the present example, the second latching means comprise three toothed projections 47, which are arranged to be offset in a manner distributed by 120° about the rotational axis a3. A different number of toothed projections 47 can alternatively be selected. In the present construction, the second latching means 35 are arranged radially outside the rotational axis a3 relative to the second retaining means 25, which is advantageous in terms of a compact design.

FIG. 6 is a rear view of the receiving device 20. It shows that the first latching means 34 are formed by teeth 57, which surround the cut-out 26 or, in other words, are formed on an edge region 53 of the cut-out 26 facing the base part 31. In the present example, the teeth are formed over an angle of 360° based on the rotational axis a3. This allows for locking in all the rotational positions of the receiving device 20 relative to the base part 31 over an angle of 360°. If less adjustability of the receiving device 20 is desired, the first latching means 34 can also just be formed over a smaller angle, e.g. 90° from the vertical in both rotational directions p1 and p2.

FIGS. 7 and 8 show that the teeth 57 take up little installation space and their extension in the direction x1 and x2 is low.

FIGS. 10 and 11 show details of the retaining device 30 and the locking device 40. FIG. 10 shows the engagement of the toothed projection 47 into a cut-out in the teeth 57. The teeth 47 and 57 are configured as a latching device here, such that, when a minimum torque on the receiving device 20 is exceeded in one of the rotational directions p1 or p2, the toothed projection 47 automatically moves out of engagement with the teeth 57 in the direction x2 and moves into engagement with the teeth 57 in the set rotational position owing to the restoring force of the spring bar 29. FIG. 11 shows how the hook projection 42 releasably engages over the edge surface 43 in the latched position.

FIG. 12 to 15 show, by way of example, different pivot positions of the receiving device 20 relative to the base part 31. In FIG. 12, an angle α1 of approximately 30° is formed between a central longitudinal axis m1 of the receiving device 20 and a central longitudinal axis m2 of the base part 31. In FIG. 13, the angle α2 between the central longitudinal axes m1 and m2 is approximately 70° and, in FIG. 14, the angle α3 between the central longitudinal axes m1 and m2 is approximately 90°.

The locking device 50, by means of which the cutter 22 retained in the receiving space 12 can be prevented from being removed, is explained in the following. The locking device 50 comprises the button 18, which is pivotally mounted about a pivot axis a1. The geometric pivot axis a1 is formed by a physical shaft 39 (only shown in FIG. 4), which is mounted in shaft cut-outs 41 in the receiving device 20 and forms a joint G1 together therewith (see FIGS. 16 and 17).

The button 18 is configured as a two-armed lever and, according to FIG. 16, comprises regions 48 and 49, wherein the region 48 is above the pivot axis a1 and the region 49 is below the pivot axis a1. The actuator 18 can be moved between a locked position and a released position in the manner of a rocker by applying pressure to the relevant region 48 or 49. FIG. 16 shows the released position and FIG. 17 shows the locked position. FIG. 18 is a front view of the carrying device, wherein the locking device 50 is in the locked position.

FIG. 18 shows that the region 48 has a greater longitudinal extension I2 from the pivot axis a1 in the direction z than the region 49, which has a longitudinal extension I3. Furthermore, the region 48 is provided with a greater surface area than the region 49. The locked position is therefore easier to set than the released position.

The button 18 is surrounded by a raised edge ridge 32, as a result of which it is haptically distinguished and can be easily pressed without being looked at.

The sectional view according to FIG. 19 shows that, in the locking position, a locking pin 52 of the actuator 18 extends through a through-opening 51 in the wall 13 of the receiving device 20 and engages in the receiving space 12. The button can be pivoted about the axis a1 in the directions v1 and v2. In the released position, which is shown in the sectional view according to FIG. 9, the button 18 has been pivoted in the direction v1 in relation to the position according to FIG. 19 and the locking pin 52 hardly projects into the receiving space 12 at all. From the position according to FIG. 9, the locked position is reached by pivoting in the direction v2.

FIG. 19 to 22 show that the locking pin 52 is located in the movement path of a cutter 22 received in the receiving space 12—here, a housing wall 55 of the cutter 22—when the cutter 22 is moved in the direction z2. It is therefore not possible to remove the cutter 22 or for it to unintentionally fall out.

FIG. 23 is a side view of the carrying device 10 based on FIG. 2, wherein a closure device 60 is provided for fastening the carrying device 10 to a belt or a bar. It comprises a closure part 36, which forms a pivot joint G2 together with the base part 31. For this purpose, the base part 31 forms primary joint means 27, which interact with secondary joint means 38 of the closure part 36.

A free end region 54 of the closure part 36 can be pivoted away from the base part 31 by means of the pivot joint G2 relative to the base part 31 about the pivot axis a2 (see FIGS. 23 and 24). According to FIG. 23, the closure part 36 has been pivoted away from the base part 31, such that, for example, a belt can be arranged between the base part 31 and the closure part 36.

At the end region 54, the closure part 36 comprises two elastically deformable arms 33, which are each formed to have a closure projection 37. The arms 33 can be moved resiliently towards one another according to the arrows q1 such that the closure projections 37 can be moved out of the locking relationship with closure cut-outs 28 of the base part 31 by means of actuating levers 44. By relieving the pressure on the actuating levers 44, the latching projections 37 can move away from one another again according to the arrows q2 into engagement with the closure cut-outs 28 owing to resilient restoring force.

In this way, the carrying device 10 can e.g. be secured to a belt 54 or a bar by it being arranged between the base part 31 and the closure part 36, the closure part 36 then being brought into a parallel position relative to the base part 31, and the closure projections 37 then being brought into engagement with the closure cut-outs 28.

Alternatively, the joint G2 could also be configured as a film hinge, such that the base part 31 and the closure part 36 are interconnected in one piece. Alternatively, the closure part 36 and the base part 31 could also be formed in one piece and connected by a resilient region which replaces the joint G2. In this case, the base part 31 and the closure part 36 would be connected in the manner of a clasp and the fastening device would not comprise a closure device comprising e.g. a closure projection and a closure cut-out.

According to another alternative, the retaining device 30 e.g. comprises a one-piece U-shaped part 69 (see FIGS. 32 and 33) comprising two legs 71 and 72 and a connecting bar 73, which replaces the base part 31 and the closure part 36. Furthermore, in this case, the retaining device 30 comprises a shutting part 70, which forms a joint e.g. with the leg 71 and comprises first locking means 74, which can be releasably brought into engagement with second locking means 75 of the leg 72. The carrying part 58 can be arranged between the legs 71 and 72 when the locking means 74 and 75 are not in engagement (see FIG. 32). The first locking means 74 and the second locking means 75 can then be brought into engagement (see FIG. 33). The carrying device 10 then cannot be unintentionally released from the carrying part 58. The spring bars 29, the hook projections 42, the blocks 46 and the toothed projections 47 are likewise formed on the U-shaped part 69 according to the base part 31.

FIG. 25a to 25f show a carrying part 58 as an individual part, to which the fastening device 60 of the carrying device 10 can be fastened. The carrying part 58 in turn comprises fastening regions 59a and 59b for mounting on a wall e.g. of a piece of furniture or a property. A mounting region 61 of the carrying part 58 to which the fastening device 60 can be fastened is located between the fastening regions 59a and 59b.

The fastening regions 59a and 59b are provided with fastening means, which are in the form of holes 62 and tabs or eyes 64 in this example. The holes 62 are e.g. provided for a screwed fastening using screws 63, or e.g. a riveted fastening, and the tabs 64 are provided for fastening the carrying part 58 by means of cable ties, wires, etc.

FIG. 25c shows that a fastening plane 65 formed by the fastening regions 59a and 59b is at a distance from a mounting plane 66 formed by the mounting region 61 by a length I4 in order for it to be possible to easily introduce the closure part 36 or optionally a second leg (not shown) of a fastening part between e.g. a wall and the mounting region 61 of the carrying part 58, such that the mounting region 61 is in contact with a first contact surface 67 on the base part 31 and with a second contact surface 68 on the closure part 36.

FIG. 26 to 31 show the carrying device 10 as being mounted on the carrying part 58 by means of the fastening device 60. A wall of a piece of furniture or a building to which the carrying part 58 is fastened by means of the fastening regions 59a and 59b is not shown.

1-12. (canceled)

13. A fastening device for fastening a portable receiving device for a tool to a bar-like carrying part, wherein the receiving device has a receiving space for receiving the tool and has a retaining device for mounting the receiving device on the fastening device and including a second retaining element assigned to the fastening device so as to interact with a first retaining element of the receiving device, wherein the fastening device comprises: a first contact surface; and a second contact surface that faces the first contact surface so that the bar-like carrying part is releasably positionable between the first contact surface and the second contact surface.

14. The fastening device according to claim 13, wherein the first contact surface is assigned to the receiving device or to a base part that is connected to the second retaining element.

15. The fastening device according to claim 14, wherein the second contact surface is assigned to a closure part that forms a joint together with the base part.

16. The fastening device according to claim 13, wherein the first contact surface and the second contact surface are on a fastening part that is connected to the second retaining element.

17. The fastening device according to claim 16, wherein the fastening part is U-shaped and comprises a first leg, to which the first contact surface is assigned, and a second leg, to which the second contact surface is assigned.

18. The fastening device according to claim 17, wherein the first leg and the second leg are interconnected by a resilient region.

19. The fastening device according to claim 17, wherein a bar of the U-shaped fastening part connecting the first leg and the second leg is opposite an opening that is closable by a closure part.

20. The fastening device according to claim 13, wherein the tool is a cutter or comprises a cutter.

21. The fastening device according to claim 13, further comprising a carrying device having a carrying part, wherein the carrying part is a piece of clothing, a carrying element or a carrying adapter that is fastenable to a wall of a piece of furniture or a property.

22. The fastening device according to claim 21, wherein the carrying part comprises at least one fastening region.

23. The fastening device according to claim 22, wherein the fastening region is formed in a fastening plane and a mounting region is substantially formed in a mounting plane that is at a distance from the fastening plane.

24. The fastening device according to claim 21, wherein the carrying part is a planar plate or a plastics part having a longitudinal extension and a width extension that are larger than a thickness of the carrying part.
